(19) United States
(12) Patent Application Publication
(10) Pub. No.: US 2010/0305986 A1
(43) Pub. Date: Dec. 2, 2010

(54) Using Service Exposure Criteria

(75) Inventors: Karthikeyan Ponnalagu, Madurai (IN); Bikram Sengupta, Bangalore (IN); Renuka R. Sindhgatta, Bangalore (IN)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/471,581

(22) Filed: May 26, 2009

(51) Int. Cl. G06Q 10/00

(52) U.S. Cl. 705/7

(57) ABSTRACT

Techniques for performing service exposure for reuse of one or more services are provided. The techniques include analyzing applicability of service criteria for a candidate service, identifying one or more services that are contextually-related to the candidate service, and using the service criteria applicable to the candidate service to expose the one or more services contextually-related to the candidate service.

### FIELD OF THE INVENTION

Embodiments of the invention generally relate to information technology, and, more particularly, to service-oriented architecture.

### BACKGROUND OF THE INVENTION

Enterprise architecture enables creating a set of enterprise-centric information assets that serve as a blueprint for operational planning and execution, and can include different types of enterprise models. Service-oriented architecture (SOA) facilitates the definition of the enterprise requirements, and through appropriate approaches, transforms these requirements into reusable services in a process referred to as service identification.

In a typical SOA model solution, each of the candidate services need to be analyzed for all the criteria manually by an architect, and once a service passes through the analysis, it can be considered for exposure. Service exposure is a costly exercise and the enterprise objective is to arrive at an optimal list of services to be specialized and exposed for inter and intra-enterprise sharing. The service exposure is a defined set of criteria to resolve whether a candidate service should be exposed. The criteria can fall into noteworthy areas such as described as follows.

One area can include enterprise alignment, which focuses on enterprise relevance of the service, the presence of a funding model to support development and maintenance, and the ability to share the service across the organization. Another area includes composability, which focuses on consistency with non-functional requirements at the composite level, consideration of state management aspects, identifying service dependencies, and supporting technology and/or platform neutrality.

Yet another area can include externalized service description, which focuses on the presence of an external service description (such as, for example, web service definition language (WSDL)), the ability to support service discovery and binding via the service description, and providing meta-data as part of the service description. Further, an area can additionally include redundancy elimination, which focuses on the ability to reuse the candidate service across multiple composite scenarios where the specific function is needed.

Existing SOA modeling and designing approaches use service litmus test (SLT) in service exposure. SLT is manually conducted through the help of a static list of questions under different categories, and it only allows users to manually choose the criteria applicable for each candidate service from a pre-defined list of criteria (questions posed by the tool). Further, the analysis for applying criteria is done by the architect manually. Disadvantageously, some of the questions from the static lists can be disconnected and irrelevant with respect to a candidate service. Also, interpreting and answering these questions remains mostly guess work, while being repetitive and heavily human-centric.

Additionally, in existing approaches, there is lack of tool-centric validation or verification on the decision arrived upon based on the SLT exercise.

As noted, existing approaches in service exposure are error prone, as they rely heavily on human introspection and interpretation based on a static list of questions. Also, existing approaches often consider each service in an independent basis without considering the surrounding business context and existing service centric context. Such approaches also do not involve analysis of semantic or syntactic closeness of different services sourced from multiple types of enterprise models, all of which results in a redundant and error-prone exercise for exposing more than an optimal set of services, which never get reused in subsequent differing enterprise requirements.

### SUMMARY OF THE INVENTION

Principles and embodiments of the invention provide techniques for using service exposure criteria. An exemplary method (which may be computer-implemented) for performing service exposure for reuse of one or more services, according to one aspect of the invention, can include steps of analyzing applicability of service criteria for a candidate service, identifying one or more services that are contextually-related to the candidate service, and using the service criteria applicable to the candidate service to expose the one or more services contextually-related to the candidate service.

One or more embodiments of the invention or elements thereof can be implemented in the form of a computer product including a tangible computer readable storage medium with computer usable program code for performing the method steps indicated. Furthermore, one or more embodiments of the invention or elements thereof can be implemented in the form of an apparatus including a memory and at least one processor that is coupled to the memory and operative to perform exemplary method steps.

Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating an existing service-oriented architecture (SOA) modeling approach;

FIG. 2 is a diagram illustrating SOA modeling, according to an embodiment of the invention;

FIG. 3 is a diagram illustrating contextual service exposure in SOA design, according to an embodiment of the present invention;

FIG. 4 is a diagram illustrating an exemplary service exposure contextual viewer for enterprise alignment, according to an embodiment of the present invention;

FIG. 5 is a block diagram illustrating an exemplary embodiment, according to an aspect of the invention;

FIG. 6 is a flow diagram illustrating techniques for performing service exposure for reuse of one or more services, according to an embodiment of the invention; and

FIG. 7 is a system diagram of an exemplary computer system on which at least one embodiment of the invention can be implemented.

### DETAILED DESCRIPTION OF EMBODIMENTS

Principles of the invention include contextual service exposure in service-oriented architecture (SOA) design. As noted above, existing approaches include a lot of redundant and often repeated manual exercise in service exposure, resulting in a huge number of services getting identified, specialized and implemented without looking at the enterprise context or reuse centric scenarios.

As such, one or more embodiments of the invention include automated service exposure for reuse of services in SOA architecture and/or framework. Additionally, the techniques detailed herein include determining and grouping of contextually-related services based on their source, domain, etc. Further, as described herein, the service criteria (for example, service exposure criteria) applicable to a service can be utilized for exposing the services contextually-related to the service.

As used herein, a service refers to a logical representation of a repeatable enterprise activity that has a specified outcome, is self-contained and can include other services. Additionally, a service can be categorized, for example, as data and/or enterprise entity services, task-oriented services, utility services, etc.

The techniques described herein include automatic analysis of service exposure criteria, which provide faster and more accurate service exposure decisions. One or more embodiments of the invention also include improving the accuracy of validating criteria, considering inputs from multiple sources (for example, processes, goals, domain, etc.). Additionally, the techniques detailed herein can include exercising well-informed and semi-automated decisions on service exposure. Further, one or more embodiments of the invention use a service operation for exposure that effectively requires understanding of current and future potential contextual information, and also reuse OrderService.placeOrder(Items) for a different context where the enterprise process could require a registered customer.

Also, the techniques described herein include identifying service clusters with similar or identical contextual bindings and domain-centric functions to optimize the service exposure decisions on a cluster basis, as well as identifying and considering inter-service dependencies for a given enterprise model (BPM) and providing dynamic validation of services to be exposed. Additionally, one or more embodiments of the invention include exposing data access services and enterprise entity lifecycle management services.

As described herein, the techniques of contextual service exposure can include reusing service identification decisions for similar service clusters and using contextual information binding the services. One or more embodiments of the invention also include eliminating weak candidate services that may never be reused across solutions, as well as enabling faster decision making towards reaching the subsequent service specification phase.

In contrast to the disadvantages of existing approaches, one or more embodiments of the invention include automatically creating multi-variant service clusters (for example, goal aligned, functional area aligned, process model aligned, data model aligned) based on the type of sources and enterprise contexts for the given model of candidate services. The techniques detailed herein also include aligning candidate services automatically to one or more of the created clusters (both contextual and solution based), as well as automatically (and/or semi-automatically) applying service exposure decision criteria to a set of candidate services.

Enterprise model centric analysis, as described herein, can include judging enterprise function alignment. For each candidate service, one can identify the set enterprise processes and/or tasks from which it is derived and the goals (for example, KPIs) to which the processes and/or tasks are associated. Also, one can identify if the candidate service is linked to an enterprise component (for example, component business modeling (CBM) Hot Components). CBM operational level can be used to decide if the candidate can be exposed externally and/or internally.

Judging composability can also include determining if a service is derived from an enterprise process, if the output of the task (for example, a process in a Websphere Business Modeler (WBM) model) is associated to the service being used as an input by another task (and also associated to the candidate service), and if the service is associated to an enterprise goal.

One or more embodiments of the invention also include externalized service description, which can include determining if the service description exists in a web service definition language (WSDL), if it is imported as an existing service, if the existing service is derived from a WebSphere Service Registry and Repository (WSRR) or any such repository, and if the service messages are linked to an extensible markup language (XML) schema definition (XSD). Additionally, the techniques described herein include redundancy elimination, which can include determining if the service is linked to a task which is widely used in the one or more enterprise processes.

Also, as described herein, for each candidate service, one or more embodiments of the invention identify source, identify source type, obtain source dependencies from multiple views, check candidates with similar inputs (for example, candidate service clusters) and get exposure criteria for the cluster candidates. The techniques detailed herein can also include analyzing the exposure criteria based on pre-defined rules (for each criteria), obtaining views representing the candidate (for each criteria), and automatically applying exposure criteria.

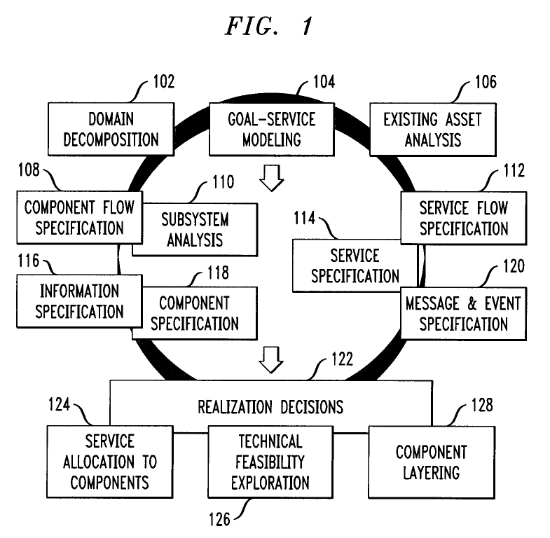

FIG. 1 is a diagram illustrating an existing service-oriented architecture (SOA) modeling approach. By way of illustration, FIG. 1 depicts components of domain decomposition 102, goal-service modeling 104 and existing asset analysis 106, which can provide input to components of component flow specification 108, subsystem analysis 110, service flow specification 112, service specification 114, information specification 116, component specification 118 and message and event specification 120. Those components can also provide input to components of realization decisions 122, service allocation to components 124, technical feasibility exploration 126 and component layering 128.

As depicted in FIG. 1, with such an approach, enterprise source(s) of the services identified for exposure are never considered, and service exposure criteria is repeated irrespective of the type of enterprise source. As such, rich contextual data available with the source model is eventually lost.

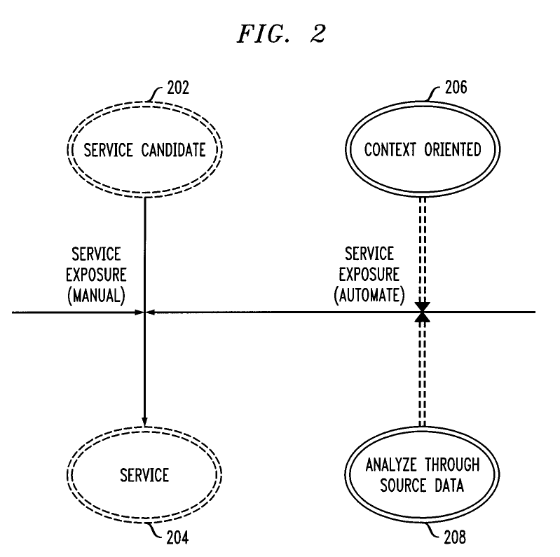

FIG. 2 is a diagram illustrating SOA modeling, according to an embodiment of the invention. By way of illustration, FIG. 2 depicts a service candidate 202, a service 204, a context-oriented component 206 and a component for analyzing through source data 208. Manual service exposure can be used, for example, for stand-alone service modeling scenarios. Also, for example, in connection with the context-oriented component 206 in automated service exposure, if service1 (S1) is exposed, so should be S2 and S3, as they are tasks dealing with the same enterprise entity. Further, by way of example, in connection with the component for analyzing through source data 208, if S1 is from functional area (FA) “XXX” (that is, one of constructs defined in the activity functional area analysis), then S1 is loosely coupled.

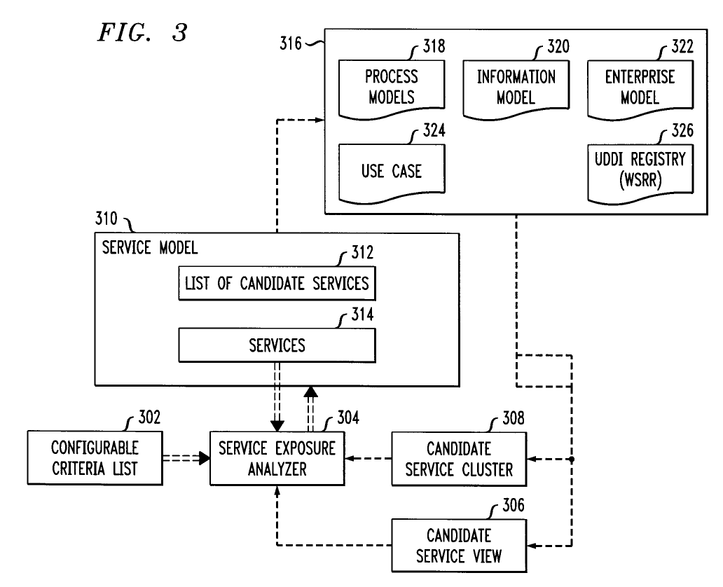

FIG. 3 is a diagram illustrating contextual service exposure in SOA design, according to an embodiment of the present invention. By way of illustration, FIG. 3 depicts a configurable criteria list 302, a service exposure analyzer 304, a candidate service view 306 and a candidate service cluster 308. Also, FIG. 3 depicts a service model 310, which includes a list of candidate services 312 and services 314. Further, FIG. 3 also depicts component 316, which includes process models 318, an information model 320, an enterprise model 322, a use case 324 and a universal description discovery and integration (UDDI) registry (for example, a WebSphere service registry and repository (WSRR)) 326.

By way of illustration, one or more of the input elements (for example, component 318, 320, 322, 324 and/or 326) within the collection 316 is taken as an input enterprise specification towards effectively defining the candidate service cluster 308 and also used to populate individual candidate service views 306. The candidate service clusters (again, one or more) can be created based on the structure and enterprise context of the associated elements that are considered for service candidature. Based on the information available from components 308 and 306, the service exposure analyzer 304 populates the service model 310 with the collection of serviced 314 that are now created and linked to the source collection of candidate services (input to 304), which also becomes part of service model 310 that traces back component 316. The service exposure analyzer 304 can also consider exposure criteria list 302 and existing sets of exposed services 314 before proceeding to automate service exposure decisions.

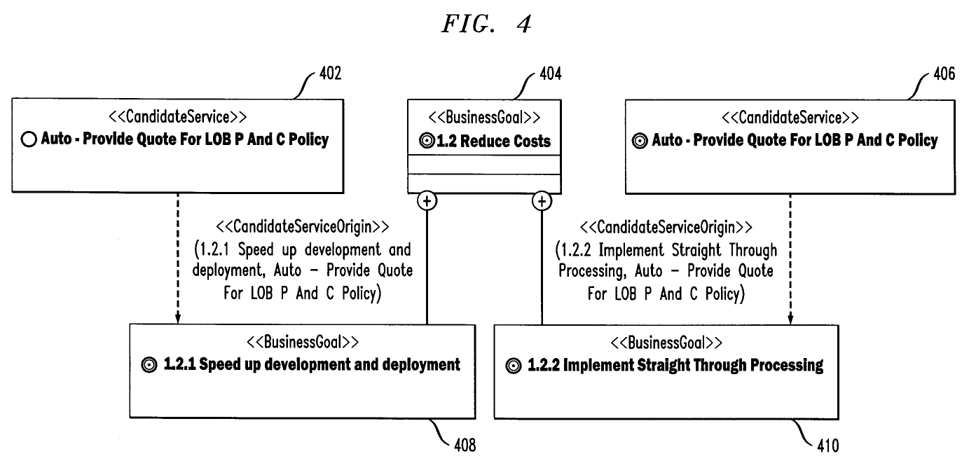

FIG. 4 is a diagram illustrating an exemplary service exposure contextual viewer for enterprise alignment, according to an embodiment of the present invention. By way of illustration, FIG. 4 depicts block 402, which illustrates the candidate service aligned with the enterprise/business sub-goal 408, block 404, which illustrates the goal model hierarchy through which both 408 and 410 are sub goals to the main goal 404, and that also mandates reduced cost as its objective. FIG. 4 also depicts block 406, which shows the candidate service aligned with the enterprise/business sub-goal 408, block 408, which as noted herein depicts a specific enterprise/business sub-goal that mandates speed up development and deployment. Further, FIG. 4 depicts block 410, which illustrates another enterprise/business sub-goal that illustrates a specific implementation through processing logic.

FIG. 4 illustrates a typical enterprise scenario specific to goal service modeling (for example, one of the enterprise-specification contexts) that characterizes a typical candidate service considered for service exposure. The candidate service being associated with such a context (aligned with a hierarchical enterprise goal), the exposure decisions (both manual and automated) that have been taken to previous such similar associations, and the exposure criteria list that contains the specific condition with respect to goal service modeling based service exposure all contribute to the exposure decision of these candidate services.

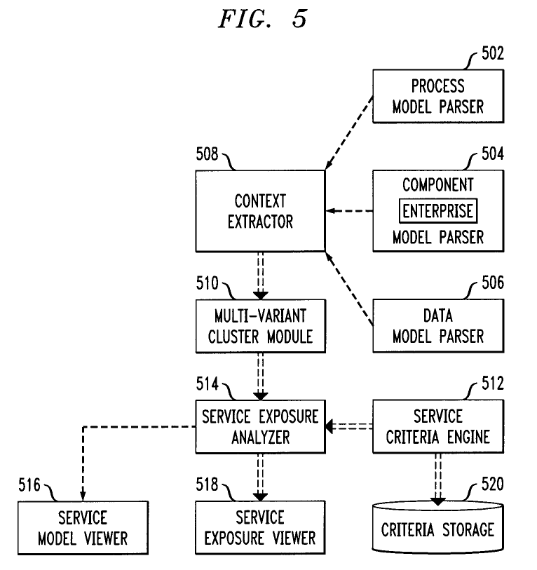

FIG. 5 is a block diagram illustrating an exemplary embodiment, according to an aspect of the invention. FIG. 5 illustrates the different software modules that co-exist and interact to perform one or more embodiments of the invention, as detailed herein. By way of illustration, FIG. 5 depicts a process model parser module 502, a component enterprise model parser module 504, and a data model parser module 506, which can all provide input to a context extractor module 508. A context extractor module 508 can provide input to a multi-variant cluster module 510, which can provide input to a service exposure analyzer module 514. Additionally, a service criteria engine module 512 can provide input to a service exposure analyzer module 514 as well as a criteria storage module 520. Further, a service exposure analyzer module 514 can provide input to a service model viewer module 516 and a service exposure viewer module 518.

On receiving a enterprise specification model (such as, for example, CBM Model, Process Model or Data Model), the respective parsers 502, 504 and/or 506 parse the information which is specific in terms of syntax and semantics and convert this into a standard format that context extractor 508 can use for extracting the expected contextual information required for service exposure consideration. Based on the structure and semantics of the available information, context extractor 508 can then pass on the context details and the associated elements specific to clustering details of the different candidate services that can be part of the incoming model to the multi-variant cluster module 510. The multi-variant cluster module 510 can use this to construct multi-variant clusters containing one or more candidate services that can be part of one such cluster based on the contextual data.

Additionally, this cluster information can be passed on to a service exposure analyzer 514, which is based on the rules specified with respect to exposure criteria by 512 (that is stored in criteria storage 520), accordingly performs the final level of analysis related to service exposure on each of the concerned candidate services. Further, the service exposure analyzer 514 can be used to provide multiple user preferred views via a service exposure viewer 518. Similarly, the change of state on service exposure with respect to each of the services can also be reflected with respect to the latest changes on the service model, which can still be evolving and can be viewed by service model viewer 516.

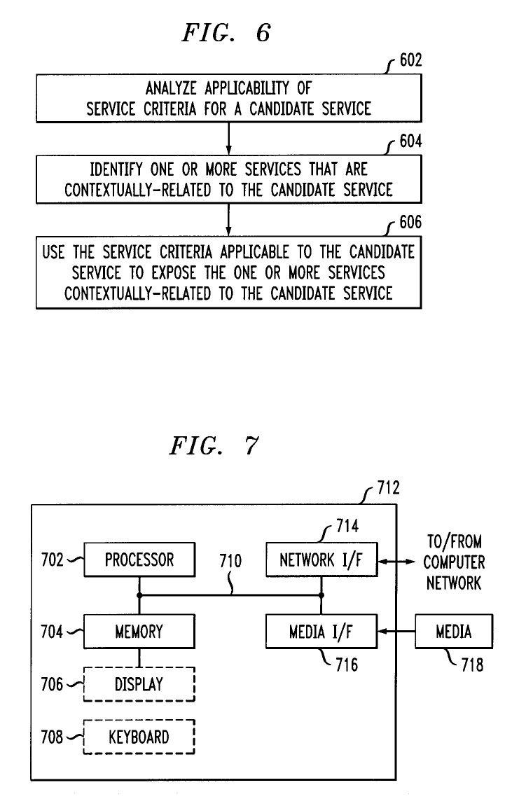

FIG. 6 is a flow diagram illustrating techniques for performing service exposure for reuse of one or more services, according to an embodiment of the present invention. Step 602 includes analyzing applicability of service criteria (for example, service exposure criteria) for a candidate service. This step can be carried out, for example, an analyzer module executing on a hardware processor. An analyzer module can include a pre-defined set of rules that do the applicability analyzing. Additionally, analyzing applicability of service criteria for a candidate service can include identifying source, source type, and/or source dependencies from one or more views.

Step 604 includes identifying one or more services that are contextually-related to the candidate service. This step can be carried out, for example, using a cluster view module executing on a hardware processor. A cluster view module includes a cluster view of the selected candidate service. Additionally, identifying services that are contextually-related to the candidate service can include identifying service clusters with similar contextual binding and domain-centric function.

Step 606 includes using the service criteria applicable to the candidate service to expose the one or more services contextually-related to the candidate service. This step can be carried out, for example, using a service exposure analyzer module as well as a service exposure viewer module, which can also automate the service exposure and/or give a user interface (UI) guided action for the user to execute this task. Also, using the service criteria applicable to the candidate service to expose the services contextually-related to the candidate service can include reusing one or more service identification decisions for the services and using contextual information binding the services. Exposing enables services to be reused (for example, as a design-time element or as a run-time element in future requirements).

The techniques depicted in FIG. 6 can also include, as described herein, providing a system (and/or being run on a system), wherein the system includes distinct software modules, each of the distinct software modules being embodied on a tangible computer-readable recordable storage medium.

One or more embodiments of the invention can also include validating previously made exposure decisions (for example, in terms of changed enterprise and solution contexts). This step can be carried out, for example, using the analyzer module executing on a hardware processor. Also, validating previously made exposure decisions can additionally include improving accuracy of validating criteria by using inputs from one or more sources (for example, processes, goals, domain, etc.).

The techniques depicted in FIG. 6 also include displaying the service criteria applicable to the candidate service to a user (user judgment, by way of example, can be used in applying the criteria on a service manually or through the analyzer). This step can be carried out, for example, using a viewer module executing on a hardware processor. One or more embodiments of the invention can also include eliminating services that will not be reused across one or more solutions. This step can be carried out, for example, using a service exposure analyzer module.

Additionally, the techniques depicted in FIG. 6 include creating a service cluster (for example, goal aligned, functional area aligned, process model aligned and/or data model aligned service cluster) based on type of source and enterprise context for a given model of one or more services. This step can be carried out, for example, using a multi-variant cluster module. One or more embodiments of the invention also include aligning the candidate service to the service clusters (both contextual and solution based). This step can be carried out, for example, using a multi-variant cluster module as well as a service exposure analyzer module. Further the techniques depicted in FIG. 6 can include applying the service criteria to the service cluster. This step can be carried out, for example, using a service criteria engine module as well as a service exposure analyzer module.

Additionally, the techniques depicted in FIG. 6 can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

A variety of techniques, utilizing dedicated hardware, general purpose processors, firmware, software, or a combination of the foregoing may be employed to implement the present invention or components thereof. One or more embodiments of the invention, or elements thereof, can be implemented in the form of a computer product including a computer usable medium with computer usable program code for performing the method steps indicated. Furthermore, one or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 7, such an implementation might employ, for example, a processor 702, a memory 704, and an input/output interface formed, for example, by a display 706 and a keyboard 708. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like.

In addition, the phrase “input/output interface” as used herein, is intended to include, for example, one or more mechanisms for inputting data to the processing unit (for example, mouse), and one or more mechanisms for providing results associated with the processing unit (for example, printer). The processor 702, memory 704, and input/output interface such as display 706 and keyboard 708 can be interconnected, for example, via bus 710 as part of a data processing unit 712. Suitable interconnections, for example via bus 710, can also be provided to a network interface 714, such as a network card, which can be provided to interface with a computer network, and to a media interface 716, such as a diskette or CD-ROM drive, which can be provided to interface with media 718.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 718) providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a tangible computer-readable storage medium include a semiconductor or solid-state memory (for example memory 704), magnetic tape, a removable computer diskette (for example media 718), a random access memory (RAM), a read-only memory (ROM), a rigid magnetic disk and an optical disk (but exclude a propagation medium). Current examples of optical disks include compact disk-read only memory (CD-ROM), compact disk-read/write (CD-R/W) and DVD.

A data processing system suitable for storing and/or executing program code will include at least one processor 702 coupled directly or indirectly to memory elements 704 through a system bus 710. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 708, displays 706, pointing devices, and the like) can be coupled to the system either directly (such as via bus 710) or through intervening I/O controllers (omitted for clarity).

Network adapters such as network interface 714 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 712 as shown in FIG. 7) running a server program. It will be understood that such a physical server may or may not include a display and keyboard.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention have been described herein with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a tangible computer-readable storage medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, it should be noted that any of the methods described herein can include an additional step of providing a system comprising distinct software modules embodied on a tangible computer readable storage medium; the modules can include any or all of the components shown in FIG. 5. The method steps can then be carried out using the distinct software modules and/or sub-modules of the system, as described above, executing on a hardware processor. Further, a computer program product can include a tangible computer-readable storage medium with code adapted to be executed to carry out one or more method steps described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, automated service exposure for reuse of services in SOA architecture and/or framework.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for performing service exposure for reuse of one or more services, comprising the steps of:
analyzing applicability of service criteria for a candidate service;
identifying one or more services that are contextually-related to the candidate service; and
using the service criteria applicable to the candidate service to expose the one or more services contextually-related to the candidate service.

2. The method of claim 1, wherein the method is run on a system, wherein the system comprises distinct software modules, each of the distinct software modules being embodied on a tangible computer-readable recordable storage medium, and wherein the distinct software modules comprise an analyzer module, a cluster view module, and a service exposure analyzer module;
wherein:
the step of analyzing applicability of service criteria for a candidate service is carried out by the analyzer module executing on the hardware processor;
the step of identifying one or more services that are contextually-related to the candidate service is carried out by the cluster view module executing on the hardware processor; and
the step of using the service criteria applicable to the candidate service to expose the one or more services contextually-related to the candidate service is carried out by the service exposure analyzer module executing on the hardware processor.

3. The method of claim 2, wherein:
the step of analyzing applicability of service criteria for a candidate service comprises the analyzer module, executing on the hardware processor, identifying at least one of source, source type, and one or more source dependencies from one or more views.

4. The method of claim 2, wherein:
the step of identifying one or more services that are contextually-related to the candidate service comprises the cluster view module, executing on the hardware processor, identifying one or more service clusters with similar contextual binding and domain-centric function.

5. The method of claim 2, wherein:
the step of using the service criteria applicable to the candidate service to expose the one or more services contextually-related to the candidate service comprises the service exposure analyzer module, executing on the hardware processor, reusing one or more service identification decisions for the one or more services and using contextual information binding the one or more services.

6. The method of claim 2, wherein:
the distinct software modules comprise the analyzer module, and wherein:
validating one or more previously made exposure decisions is carried out by the analyzer module executing on a hardware processor, and wherein the step of validating one or more previously made exposure decisions further comprises the analyzer module, executing on the hardware processor, improving accuracy of validating criteria by using one or more inputs from one or more sources.

7. The method of claim 2, wherein:
the distinct software modules further comprise a viewer module, and wherein:
displaying the service criteria applicable to the candidate service to a user is carried out by the viewer module executing on a hardware processor.

8. The method of claim 2, wherein:
the distinct software modules further comprise a multi-variant cluster module and the service exposure analyzer module, and wherein:
creating a service cluster based on type of source and enterprise context for a given model of one or more services is carried out by the multi-variant cluster module executing on a hardware processor;
aligning the candidate service to the service clusters is carried out by the multi-variant cluster module executing on a hardware processor; and
applying the service criteria to the service cluster is carried out by the service exposure analyzer module executing on a hardware processor.

9. A computer program product comprising a tangible computer readable recordable storage medium including computer useable program code for performing service exposure for reuse of one or more services, wherein the computer usable program code comprises one or more distinct software modules, the computer program product including:
computer useable program code for analyzing applicability of service criteria for a candidate service;
computer useable program code for identifying one or more services that are contextually-related to the candidate service; and
computer useable program code for using the service criteria applicable to the candidate service to expose the one or more services contextually-related to the candidate service.

10. The computer program product of claim 9, wherein the computer useable program code for analyzing applicability of service criteria for a candidate service comprises computer useable program code for identifying at least one of source, source type, and one or more source dependencies from one or more views.

11. The computer program product of claim 9, wherein the computer useable program code for identifying one or more services that are contextually-related to the candidate service comprises computer useable program code for identifying one or more service clusters with similar contextual binding and domain-centric function.

12. The computer program product of claim 9, wherein the computer useable program code for using the service criteria applicable to the candidate service to expose the one or more services contextually-related to the candidate service comprises computer useable program code for reusing one or more service identification decisions for the one or more services and using contextual information binding the one or more services.

13. The computer program product of claim 9, further comprising:
computer useable program code for creating a service cluster based on type of source and enterprise context for a given model of one or more services;
computer useable program code for aligning the candidate service to the service clusters; and
computer useable program code for applying the service criteria to the service cluster.

14. The computer program product of claim 9, wherein the one or more distinct software modules comprise an analyzer module, a cluster view module, a service exposure analyzer module, a viewer module, and a multi-variant cluster module executing on a hardware processor.

15. A system for performing service exposure for reuse of one or more services, comprising:
a memory; and
at least one processor coupled to the memory and operative to:
analyze applicability of service criteria for a candidate service;
identify one or more services that are contextually-related to the candidate service; and
use the service criteria applicable to the candidate service to expose the one or more services contextually-related to the candidate service.

16. The system of claim 15, wherein the at least one processor coupled to the memory operative to analyze applicability of service criteria for a candidate service is further operative to identify at least one of source, source type, and one or more source dependencies from one or more views.

17. The system of claim 15, wherein the at least one processor coupled to the memory operative to identifying one or more services that are contextually-related to the candidate service is further operative to identify one or more service clusters with similar contextual binding and domain-centric function.

18. The system of claim 15, wherein the at least one processor coupled to the memory operative to use the service criteria applicable to the candidate service to expose the one or more services contextually-related to the candidate service is further operative to reuse one or more service identification decisions for the one or more services and using contextual information binding the one or more services.

19. The system of claim 15, wherein the at least one processor coupled to the memory is further operative to:
create a service cluster based on type of source and enterprise context for a given model of one or more services;
align the candidate service to the service clusters; and
apply the service criteria to the service cluster.

20. The system of claim 15, further comprising a tangible computer-readable recordable storage medium having one or more distinct software modules embodied thereon, the one or more distinct software modules comprising an analyzer module, a cluster view module, a service exposure analyzer module, a viewer module, and a multi-variant cluster module.
